(19) United States
(12) Patent Application Publication
(10) Pub. No.: US 2007/0282657 A1
(43) Pub. Date: Dec. 6, 2007

(54) METHOD AND SYSTEM FOR PROVIDING ACTIVITY-CENTRIC AWARENESS IN A VIRTUAL COLLABORATION SPACE WITH PERSONALIZED DIFFERENTIAL AWARENESS USER INTERFACE REPRESENTATIONS

(76) Inventors: Susanne Hupfer, Lexington, MA (US); Steven Ross, South Hamilton, MA (US); John Patterson, Carlisle, MA (US)

Correspondence Address: LOTUS AND RATIONAL SOFTWARE;McGuinness & Manaras LLP, 125 NAGOG PARK, ACTON, MA, 01720, US

(21) Appl. No.: 11/421,452

(22) Filed: May 31, 2006

(51) Int. Cl. G06F 15/02

(52) U.S. Cl. 705/9

(57) ABSTRACT

A system for providing an activity-centric collaboration space provides representations of the tasks that the team has planned, is engaged in, and has completed as a means of enhancing cross-team awareness and coordination. The system enables a user to explicitly indicate what task she is currently engaged in on behalf of the team, and makes this current task information available to other team members. A “tasks” view user interface component provides a shared view of all ongoing, planned, and completed tasks for a team. Information about team members' task assignments, and the ability to monitor team members' current tasks, may be used to manage potential interruptions caused by requests for instant messaging sessions and the like. Team members can explicitly establish interruption management policies indicating how task assignments and current tasks should be used to determine whether a communication attempt should be blocked or forwarded to a team member. Team space resources that are most important to an individual team member may also be identified, and changes made to those resources made more visually apparent and/or readily available to that user than changes to artifacts with which they are less concerned. Personalized differential awareness user interface representations may also be provided, and the associations that tasks establish between resources and team members also enables convenient determination of whether newly added or modified resources would be of interest to a particular user.

### FIELD OF THE INVENTION

The present invention relates generally to computer supported collaboration work, and more specifically to a method and system for providing an activity-centric collaboration space with personalized differential awareness user interface representations.

### BACKGROUND OF THE INVENTION

There are many existing approaches to supporting groups of people who must collaborate closely on a project using computer software systems. Previous systems, such as IBM® Lotus Notes Databases, IBM® Workplace Team Collaboration™ team spaces, Wikis, and IBM® Lotus QuickPlace, have all supported team collaboration, but have sometimes fallen short. A frequent use pattern for this type of tool is that there is an initial enthusiastic adoption followed by a gradual drop in usage until the virtual collaboration space they create becomes nearly dormant. Usage of the collaboration space often does not last as long as the team itself, and team members may fall back on general purpose collaboration tools such as electronic mail (“email”) and instant messaging to support their collaboration. Accordingly, while virtual collaboration spaces are generally a good idea for improving team productivity, particularly for geographically distributed teams, the shortcomings of existing systems should be addressed in order to achieve better long-term adoption of these tools.

One shortcoming of existing systems is insufficient awareness of the activities of other team members, such as the tasks planned for a project, which task each member is currently working on, the status of each task, and/or which task has been completed. This lack of awareness can result in a lack of team coordination, reduced team cohesion, and reduced understanding of the team's progress on the project. Team members need to have a good sense of what is going on across the team in order to optimally participate, and they need to have a feeling for what is going on within the collaboration space in order to be drawn to use it, and to continue to use it long-term.

In addition, within a collaboration space, it is useful to provide users with a way to be aware of whether artifacts, discussions, and/or tasks in the space are new to them (i.e. never read), or have already been read by them, or have been modified by others since last read by them. Existing systems, such as email or news readers, sometimes distinguish these states by coloring artifacts differently, using different fonts, or decorating artifacts with various ornaments. However, in a large space populated with many artifacts or in a space where changes are frequent, the sheer volume of awareness indicators may become overwhelming to the point of being unhelpful.

Within a particular virtual collaboration space, it is often the case that individual members of the space are personally concerned with only a fraction of the artifacts contained in the space. When such a space relates to one's work (as opposed to a system for more casual reading, such as a news reader), it becomes even more important for a user to be able to distinguish and easily locate items that are new or modified and of particular personal relevance.

For the above reasons and others, it would be desirable to have a new system for supporting collaboration between team members through a virtual collaboration space, in which team members are provided with improved awareness with regard to the activities of other team members. The new system should also enable a user to be able to distinguish and easily locate items that are new or modified and of particular personal relevance to the user.

### SUMMARY OF THE INVENTION

To address the above described and other shortcomings of previous systems, a new method and system are disclosed for providing an activity-centric, virtual collaboration space. The disclosed system provides enhanced team-wide awareness, resulting in a more cohesive team, a greater incentive for team members to use the system, and ultimately a more engaged and productive team. Graphic representations of the tasks that the team has planned, is engaged in, and has completed are displayed as a means of enhancing cross-team awareness and coordination. These task representations provide an explicit focus on the goals and sub-goals of the team, and providing awareness of the status of and activity around those goals and sub-goals to all members of the team makes the collaboration space a focal point, rather than an impediment, to getting the work done. The disclosed system advantageously enables a user to explicitly indicate what task he or she is currently engaged in on behalf of the team, and makes this information available to other team members.

A “tasks” view user interface component provides a shared view of all ongoing, planned, and completed tasks for the team. The tasks view enables all team members to know which tasks are currently underway, which team members are currently working on which task, which tasks are complete, and which tasks need to be completed. Through the tasks view, all members of the team have access to the information associated with all the tasks defined for that team, such as status, priority, description, individuals assigned, and associated artifacts for each task. Team members can see all the tasks for the team, not just the tasks to which they are assigned. When a team member engages in a task, she makes it her current task, and all team members are provided with awareness of which team members are currently working on which tasks.

The disclosed system also may be embodied to use information about a team member's task assignments, and a user's current task to manage potential interruptions caused by requests for instant messaging sessions and the like. Specifically, the disclosed system may operate to check the current task of a team member that is attempting to initiate a communication session with another team member. If the team member initiating the communication session is currently working on the same task as the receiving team member, then the communication attempt may be determined to be an “interaction” regarding the receiving team member's current task, rather than an interruption, and the communication request is accordingly presented to the receiving team member. Similarly, if the team member initiating the communication session is currently working on a task that the receiving team member considers to be important, then the communication attempt may be determined to be a desirable interaction regarding an important task, rather than an interruption, and the communication request is similarly presented to the receiving team member.

In another aspect of the disclosed system, team members can explicitly establish interruption management policies indicating how the task assignments and current task of a team member attempting to establish a communication session should be used with the task assignments and current task of the receiving team member to determine whether the communication attempt should be blocked or forwarded to the receiving team member. Accordingly, a team member can configure the disclosed system to suppress interruptions from, for example, people who are not assigned to the same tasks as they are, people who are not assigned to the task that they are currently working on, people who are not currently working on the same task that they currently are working on, people who are not currently working in the same space that they currently are working in, and/or people who are not members of the team associated with the collaboration space in which they are currently present. In this way, assignment to, and engagement in specific tasks provides a fine-grained context that is very useful in establishing interruptability of team members.

In order to provide personalized differential awareness user interface representations, the disclosed system further operates to identify artifacts, tasks, and/or other resources that are relatively more important to an individual team member and to make changes to those resources more visually apparent and/or readily available to that user than changes to resources with which they are less concerned. In one embodiment of the disclosed system, the association that tasks establish between artifacts and team members also enables convenient determination of whether modifications to a particular artifact would be of interest to a particular user.

Thus there is disclosed a new system for supporting collaboration between team members through a virtual collaboration space, in which team members are provided with improved awareness with regard to the activities of other team members. The disclosed system also enables a team member to be able to distinguish and easily identify artifacts, tasks, and/or other resources that are new or modified and of particular personal relevance, and to control interruptions based on the activities of other team members.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram showing hardware and software components in an execution environment including an illustrative embodiment of the disclosed system;

FIG. 2 is a simplified screen shot illustrating an application user interface for a virtual collaboration space generated by an embodiment of the disclosed system to enable a team member to indicate a task they are currently engaged in, and to enable the team member to determine the tasks that other members are currently engaged in;

FIG. 3 is a simplified screen shot illustrating an application user interface for a virtual collaboration space generated by an embodiment of the disclosed system to enable a team member to determine task information associated with a collaboration space artifact;

FIG. 4 is a simplified screen shot illustrating a portion of an application user interface for a virtual collaboration space generated by an embodiment of the disclosed system to enable a user to enter information related to a task;

FIG. 5 is a simplified screen shot illustrating a portion of an application user interface for a virtual collaboration space generated by an embodiment of the disclosed system to provide distinct visual representations of collaboration space artifacts, tasks, and/or other resources that have been changed and that are important to a given team member;

FIG. 6 is a flow chart illustrating steps performed in an embodiment of the disclosed system; and

FIG. 7 is a continuation of the flow chart of FIG. 6.

### DETAILED DESCRIPTION OF EXEMPLARY EMBODIMENTS

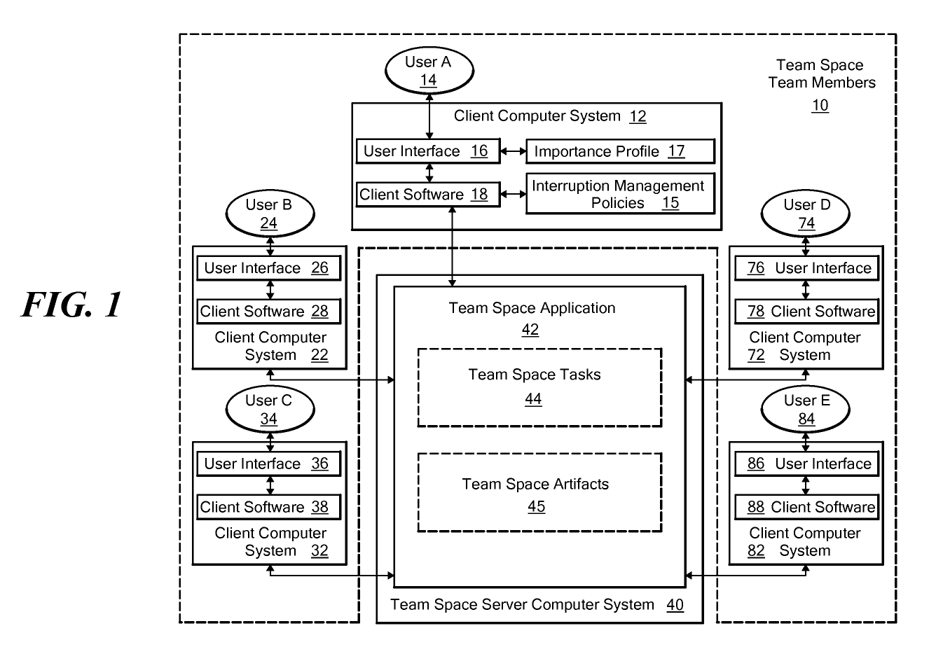

FIG. 1 is a block diagram showing hardware and software components in an execution environment for an illustrative embodiment of the disclosed system. As shown in FIG. 1, the members 10 of a Team Space provided by the Team Space Application 42 executing on a Team Space Server Computer System 40 include a User A 14, User B 24, User C 34, User D 74 and User E 84. User A 14 is provided a User Interface 16 on Client Computer System 12 by Client Software 18, User B 24 is provided a User Interface 26 on Client Computer System 22 by Client Software 28, User C 34 is provided a User Interface 36 on Client Computer System 32 by Client Software 38, User D 74 is provided a User Interface 76 on Client Computer System 72 by Client Software 78, and User E 84 is provided User Interface 86 on Client Computer System 82 by Client Software 88. The disclosed system further provides Team Space members with importance and interruption management profiles, illustrated in FIG. 1 by the Importance Profile 17 and Interruption Management Policies 15 for User A 14. While the Importance Profile 17 and Interruption Management Policies 15 are shown stored on the Client Computer System 12, they may alternatively be stored completely or partially on the Team Space Server Computer System 40.

Team Space Application 42 provides a team space that is a virtual, shared “area” or “workspace” that supports communication, coordination, and collaboration between the Team Members 10. Team Space Application 42 enables the Team Members 10 to store, organize, and retrieve Team Space Tasks 44 and Team Space Artifacts 45, which relate to a team project for which the Team Members 10 are responsible. Team Space Application 42 controls the Tasks 44 and the Artifacts 45 such that accesses to and/or operations on the Tasks 44 and the Artifacts 45 can only be performed by the Team Space Team Members 10. Team Space Artifacts 45 are one example of Team Space resources, and may include any specific type of information, for example, code files, designs, project documentation, presentations, schedules, and/or application programs. Team Space Application 42 further provides interactive, on-line discussions among Team Space Team Members 10, for example through an instant messaging and/or any other specific type of communication application that may be a resource of the Team Space.

The Team Space Tasks 44 are tasks that the Team Space Team Members 10 have planned, are engaged in, and/or have completed, for the purpose of enhancing cross-team awareness and coordination. Team Space Tasks 44 are another example of Team Space resources. Each of the tasks stored in the Team Space Tasks 44 indicates or contains task-related information such as: which of the Team Space Team Members 10 are assigned to the task, the status of the task (e.g. completed, planned, or underway), a priority associated with the task (e.g. high priority or low priority), a description of the task, and which of the Team Space Artifacts 45 are associated with the task.

While Team Space Tasks 44 and Team Space Artifacts 45 are shown for purposes of illustration in FIG. 1 as examples of Team Space resources, the disclosed system is not limited to embodiments having those specific Team Space resources. Accordingly, alternative embodiments may include any specific type of Team Space resource.

The client computer systems 12, 22, 32, 72 and 82 of FIG. 1 are communicably connected to the Team Space Server Computer System 40, for example by way of a communication network such as the Internet, a Local Area Network (LAN), or other specific type of communication network. The client software 18, 28, 38, 78 and 88 communicates with the Team Space Application program 42 to provide the respective user interfaces 16, 26, 36, 76 and 86. Client software 18, 28, 38, 78 and 88 may, for example, use a client-server approach to operating with the server software 42. Alternatively, the client software 18, 28, 38, 78 and 88 may include Web browser program functionality operable to request and receive Web page content, including HTML (Hypertext Markup Language) code or the like, from the Team Space Application 42, and to render such Web page content in their respective user interfaces.

In one embodiment, client software 18 provides the User Interface 16 responsive to information received from the Team Space Application 42, the Importance Profile 17, and the Interruption Management Policies 15. The Importance Profile 17 contains information indicating the importance of various resources, such as Team Space Tasks 44 and/or Team Space Artifacts 45 to User A 14, and/or indications of how importance determinations are to be made. The Importance Profile 17 may store information obtained from User A 14 through the User Interface 16 explicitly indicating which of the Team Space resources are to be considered important to User A 14, and/or how importance determinations are to be made.

In one embodiment, the relative importance of a Team Room resource to User A 14 is determined by the Importance Profile 17 and/or Client Software 18 based on whether that resource is associated with a task to which the user is assigned. Accordingly, in such an embodiment, a resource may be determined to be relatively more important to User A 14 than other resources in the event that the resource is associated with a task to which User A 14 is assigned. Similarly, in such an embodiment, tasks to which User A 14 is assigned are considered to be more important to the user than other tasks. The importance of a given document or other resource to a user may also, or alternatively, be determined based on whether the user authored or modified the resource. For example, those documents that were authored or modified by a user may be determined to be relatively more important to that user than other documents.

In another alternative embodiment, the Importance Profile 17 and/or Client Software 18 automatically determines whether a document is important to User A 14 by monitoring the number of times User A 14 accesses a document. Documents that have been accessed more often than other documents may be considered relatively more important. This approach to importance determination based on frequency of access may further be applied to any specific type of artifact or other resource within a Team Space.

The Interruption Management Policies 15 indicate how task assignments and current task indications of team members attempting to establish communication sessions are used with the task assignments and current task indications of receiving team members to determine whether in certain contexts, or under certain circumstances, communication attempts should be blocked or presented to the receiving team member. The Interruption Management Policies 15 may, for example, specify that a team member (e.g. User A 14) is not to be disturbed when they are currently engaged in a specific activity, e.g. a specific task, except by other users engaged in that same activity. Similarly, the Interruption Management Policies 15 may specify that a team member can be interrupted by a wider range of users, e.g. all team members, when they are engaged in some other activity, e.g. another task.

For example, the Interruption Management Policies 15 may be configured by the User A 14 to block communication session requests received from team members who are not assigned to the same tasks that the User A 14 is, from team members who are not assigned to the task that the User A 14 is currently engaged in, and/or from team members who are not currently engaged in the same task as the User A 14 at the time the communication request is received. The types of communication requests that can be controlled based on the Interruption Management Policies 15 may, for example, include requests for real time chat or instant messaging sessions, and/or any other specific type of communication session from other users or alerts or communication from the system itself.

While the Importance Profile 17 and Interruption Management Policies 15 are shown for purposes of illustration located on the Client Computer System 12, the disclosed system may be alternatively embodied such that the Importance Profile 17 and Interruption Management Policies 15 are stored partly or wholly on the Team Space Computer Server System 40. Moreover, while for purposes of concise and clear illustration only the Importance Profile 17 and Interruption Management Policies 15 for User A 14 are shown in FIG. 1, each of the other users 24, 34, 74 and 84 may similarly have an importance profile associated with and maintained for them, stored for example either on their respective client computer systems, and/or on the Team Space Computer Server System 40.

The client computer systems 12, 22, 32, 72 and 82, and Team Space Server Computer System 40, may each include at least one processor, program storage, such as memory, for storing program code executable on the processor, and one or more input/output devices and/or interfaces, such as data communication and/or peripheral devices and/or interfaces. The client computer systems 12, 22, 32, 72 and 82, and the Team Space Server Computer System 40 may each further include appropriate operating system software. The client computer systems 12, 22, 32, 72 and 82 may further include portions of an integrated development environment (IDE), such as the Eclipse IDE as provided by the Eclipse Foundation.

While for purposes of clear illustration and concise explanation FIG. 1 shows only five members of a Team Space and associated client computer systems, and one Team Space Server Computer System 40, the disclosed system is not so limited, and those skilled in the art will recognize that there may be multiple other client and/or server computer systems in an operational environment of an embodiment of the disclosed system, and that any specific number of users may be members of a given team space at a given time. While only one team is shown in FIG. 1, the disclosed system is applicable to configurations or deployments having any specific number of team spaces.

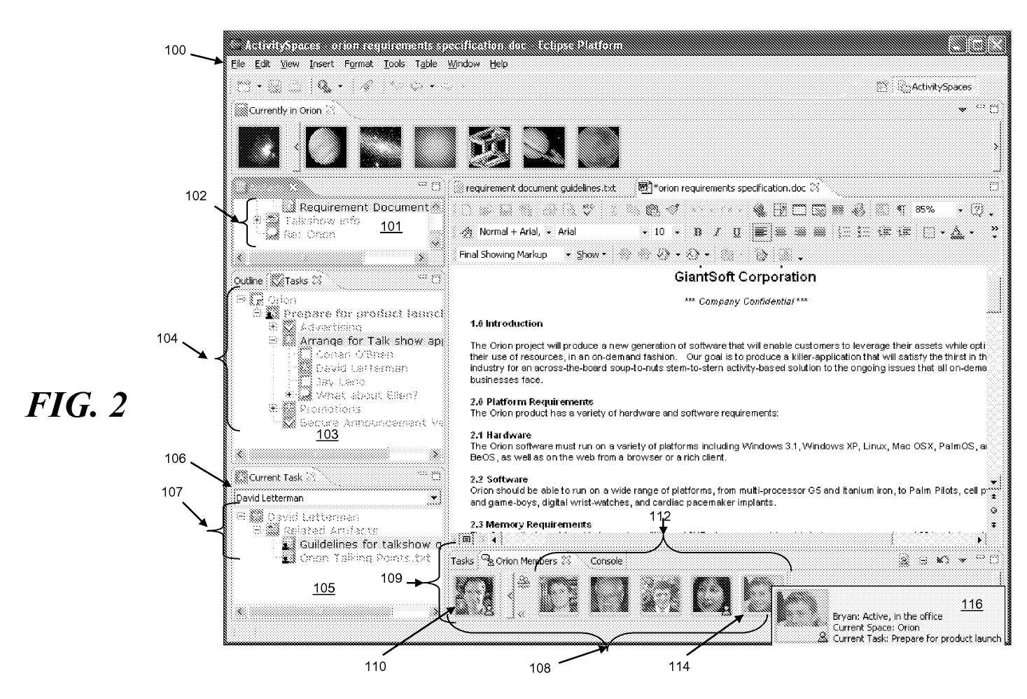

FIG. 2 is a simplified screen shot illustrating an application user interface 100 for a virtual collaboration space generated by an embodiment of the disclosed system. The user interface 100 enables a team member to indicate a task they are currently engaged in, and enables the team member to determine the tasks that other members are currently engaged in. For example, the illustrative user interface 100 of FIG. 2 is shown including an artifacts user interface component 101, containing a hierarchical “tree” (or “outline”) organization 102 of visual representations of team space artifacts. A tasks user interface component 103 includes visual representations of team space tasks, similarly organized as a hierarchical tree 104. The tree 104 includes a top level representation of the Orion team space, which in turn has under it a next lower level task entry labeled “Prepare for product launch”, representing a task within the Orion space. The “Prepare for product launch” task in turn has under it a number of sub-entities, such as representations of sub-tasks within that task. Thus the tree 104 is a hierarchical representation of task representations within team space representations, such that each task representation may have under it one or more representations of other tasks that are sub-tasks of that task.

In one embodiment, the task representations in the tree 104 have associated with them icons indicating the current status of each task. For example, tasks that are completed may be displayed next to a first type of icon, such as a check mark, while tasks that are currently under way may be displayed next to a second type of icon, such as a star, and tasks that are planned for the future may be represented by another icon type, for example a box. Other task statuses may alternatively or additionally be displayed in the tree 104 through the use of additional icon types.

A current task user interface component 105 enables the user to select a current task through, for example, a pull down menu 106. The user may, for example, be permitted to select from any task to which they have been assigned through the pull down menu 106. A hierarchical tree 107 displays information associated with the task that has been selected through the pull down menu 106, including representations of related artifacts for that task. In the example of FIG. 2, the selected current task is shown as the “David Letterman” task. The tree 107 displays artifacts and/or sub-tasks within the “David Letterman” task, shown for purposes of illustration by a “Related Artifacts” category, which includes two document artifacts associated with the “David Letterman” task.

A team member's user interface component 109 displays representations 108 of the user's current team space, in this case the members of the Orion team space. The user interface component 109 enables the user to learn a current team space and/or a current task for each of the other members of the currently selected team space. The representations 108 may be pictures or other graphical representations, and are shown including a representation 110 of the current team space member to which is being presented to the user interface 100, and representations 112 of the other members of the team space. The representations 112 of the other team space members enable the user to indicate a team member for which current task information is to be displayed. For example, when the user hovers the cursor over the team space member representation 114, a display component 116 is generated displaying various information regarding the current activities of that team member. As shown in the example of FIG. 2, the display component 116 indicates that the team space member “Bryan” associated with the team space member representation 114 is currently active, is in the office, is currently working in the Orion team space, and has indicated that they are currently working on the “Prepare for product launch” task. While the hover over display component 116 shown in FIG. 2 as one possible way to expose the current task information of another team member, the present invention is not limited to that specific technique. Alternatively, other specific user interface display mechanisms or techniques may be used to display such current task information of other team members.

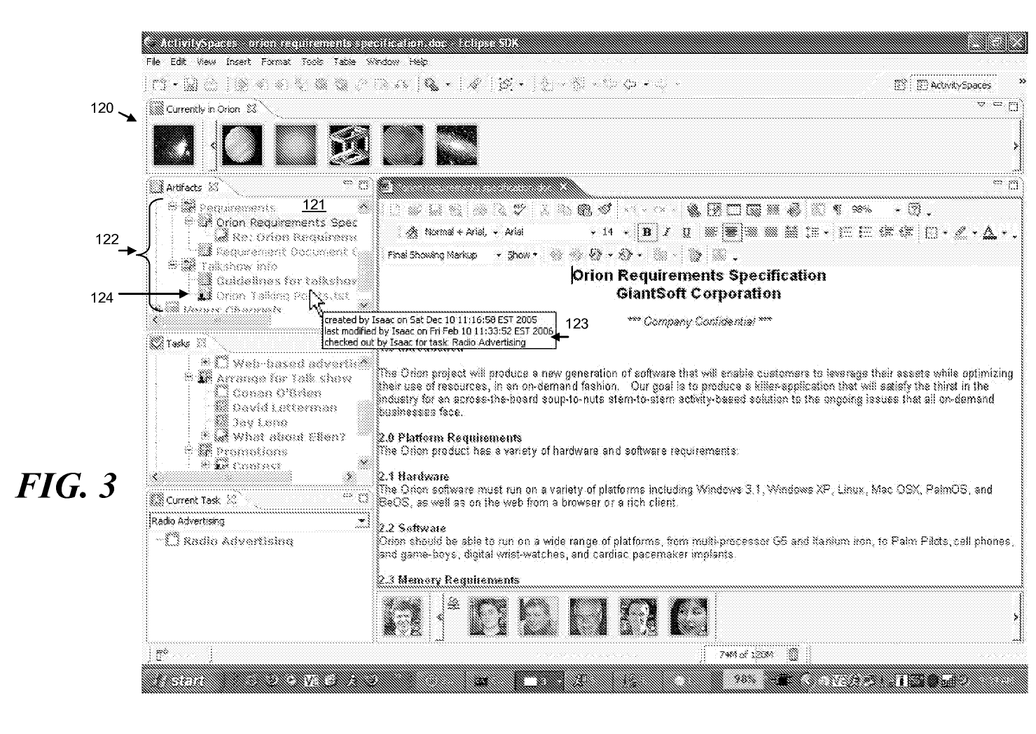

FIG. 3 is a simplified screen shot illustrating an application user interface 120 for a virtual collaboration space generated by an embodiment of the disclosed system. The user interface 120 enables a team member to determine task information associated with a team space artifact. As shown in FIG. 3, an artifacts display component 121 includes a tree 122 of artifact representations for the current team space. A hover over display component 123 is presented in response to the user hovering the cursor over the artifact 124, “Orion Talking Points.txt”. The display component 123 is an example of how a user can determine a task that another team member was working on when they checked out an artifact, through a representation of that artifact. Thus the user can determine for what purpose an artifact was checked out by another team member. In the example of FIG. 3, the artifact 124 was created and last modified by team member “Isaac”, and is currently checked out by Isaac. Isaac checked out the artifact 124 for use in connection with the “Radio Advertising” task. The display component 123 is just one example of how the present invention can be embodied to reveal associations between team members, tasks, and artifacts and any other appropriate user interface technique or mechanism may be used in alternative embodiments.

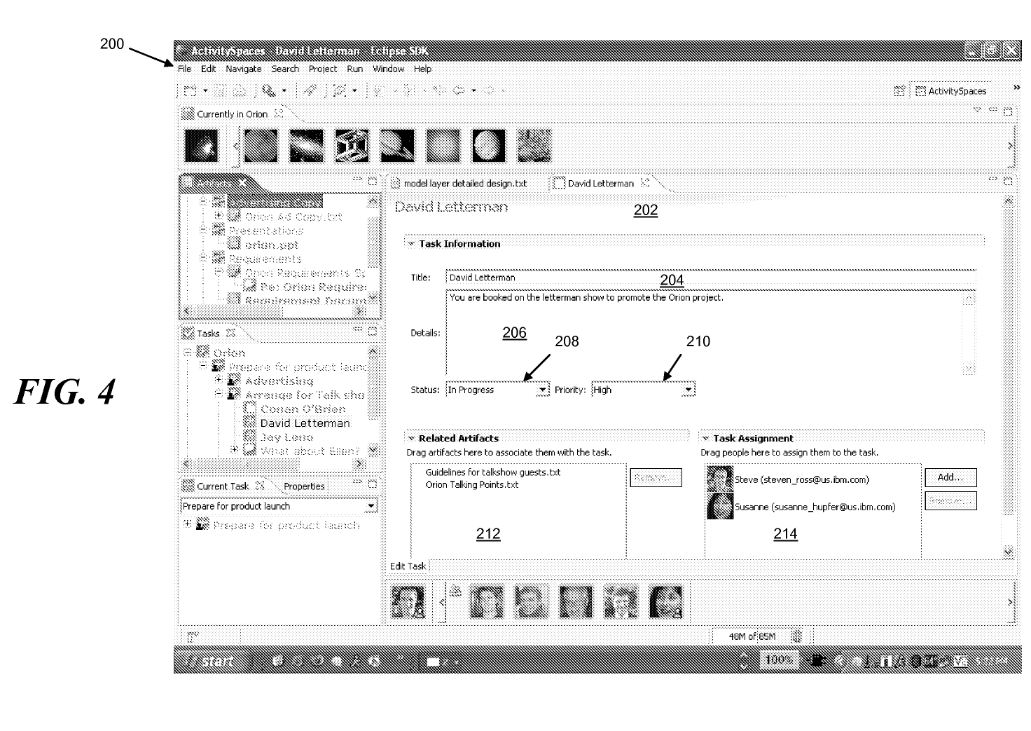

FIG. 4 is a simplified screen shot illustrating a portion of an application user interface 200 for a virtual collaboration space generated by an embodiment of the disclosed system to enable a user to enter information in association with a task. The user interface 200 includes a task form user interface 202 into which a user can enter a title for a task in the title field 204. A user can further enter details related to the task in the details field 206, select a status for the task using the pull down menu 208, and select a priority for the task using the pull down menu 210. A Related Artifacts field 212 is provided so the user can add or remove artifacts that are to be associated with the task, and a Task Assignment field 214 enables the user to indicate team members that are to be assigned to the task.

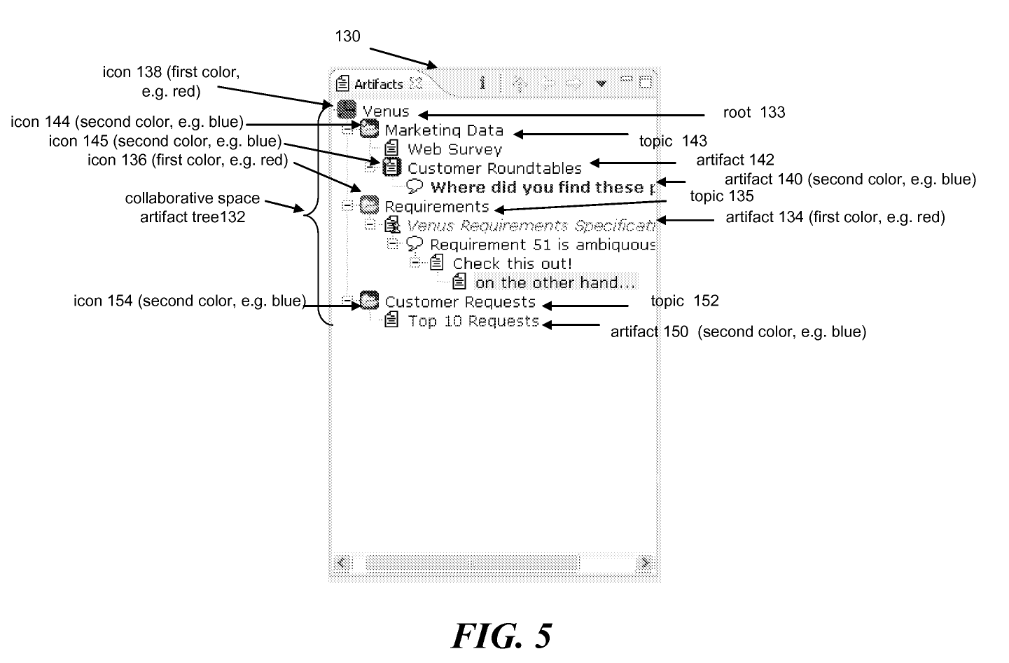

FIG. 5 is a simplified screen shot illustrating a user interface component 130 of an application user interface for a virtual collaboration space generated by an embodiment of the disclosed system. The user interface component 130 is an alternative embodiment of the display components 101 and 121 shown in FIGS. 2 and 3 respectively. A tree 132 of artifact representations within the component 130 provides visually distinct representations of collaboration space artifacts that have been recently changed or added, and that are important to a given team member.

As shown in FIG. 5, a root 133 indicates a team space Venus. In the example of FIG. 5, italic artifact representations indicate important artifacts, and bold typeface artifact representations indicate new artifacts that have not yet been seen by the user. Colored artifact representations that are not in bold typeface represent artifacts that have been modified since they were last viewed by the user. Important documents that have been created and not yet viewed by the user, as well as important documents that have been modified since they were last viewed by the user, are displayed in a first color, e.g. red. Documents that are not important to the user, but that have either been newly created by not yet viewed by the user, or that have been modified since they were last viewed by the user, are displayed in a second color, e.g. blue.

For example, the artifact representation 140, which is displayed in bold typeface and the second color, represents a relatively unimportant artifact that is new and has not yet been viewed by the user. The artifact representation 150, which is displayed in the second color but not in bold, represents an artifact that is relatively unimportant and that has been modified since it was last viewed by the user. The artifact representation 134, which is displayed in the first color, italics, and not bold, represents a relatively important artifact that has been modified since it was last viewed by the user. If the artifact represented by artifact representation 134 were important and newly created but not yet viewed by the user, then it would instead be represented in bold typeface in the first color. If the artifact represented by artifact representation 134 were important but not newly created or modified, then artifact representation 134 would be in displayed not in the first or second color (e.g. in black) and in italics.

The topic 135 is shown having an icon 136 that is also shown in the first predetermined color, in that way visually indicating to the user that the topic contains at least one important artifact that is newly created and not yet viewed by the user, or that has been modified since it was last viewed by the user. Similarly, the icon 138 is also shown in the first predetermined color, thus visually indicating that the team space includes at least one important artifact that is newly created and not yet viewed by the user, or that has been modified since it was last seen by the user. The artifact 140 is a question or topic regarding the artifact 142, and the artifact 142 has an icon 145 that is also represented in the second color, indicating the existence underneath it of the new, relatively unimportant artifact 140. Similarly, the topic 143 has an icon 144 in the second color, indicating that underneath it is the relatively unimportant artifact 140 that has been added. It should also be noted that the icons 145 and/or 144 would also be displayed in the second color in the event that a modified unimportant artifact were under them. The topic 152 also has an icon 154 displayed in the second color, again indicating that it has underneath it the modified, relatively unimportant artifact 150. The icons 144 and 145 also have displayed on them diamond “glyph” decorations, indicating that beneath them is at least one newly added artifact that has not yet been viewed by the user. Other specific visual decorations or modifications to specific icons may be used for indicating the presence of a newly added by not yet viewed artifact in alternative embodiments.

In the embodiment of FIG. 5, if an entry in the artifact tree 132 has underneath it one or more relatively important new or changed artifacts that have not yet been viewed by the user, then that entry has associated with it an icon displayed in the first color, e.g. red, indicating the presence of the new or changed artifacts. This is true even if that same entry in the artifact tree 132 also has underneath it one or more new or changed artifacts that are relatively unimportant to the user.

While in the example of FIG. 5, color is used to distinguish between representations of those changed or new artifacts that are relatively more important to the user, and representations of other changed or new artifacts that are relatively less important to the user, this is only one possible embodiment. Alternatively, the disclosed system may use any other specific contrasting visual characteristic to distinguish those changed or new artifacts that are relatively more important to the user from other changed or new artifacts.

Additionally, while the example of FIG. 5 is presented for purposes of illustration with regard to displaying artifact representations, the disclosed system may be embodied to use the same principles of visual distinction based on relative importance to provide representations of any other specific type of Team Room resource, including, for example, tasks.

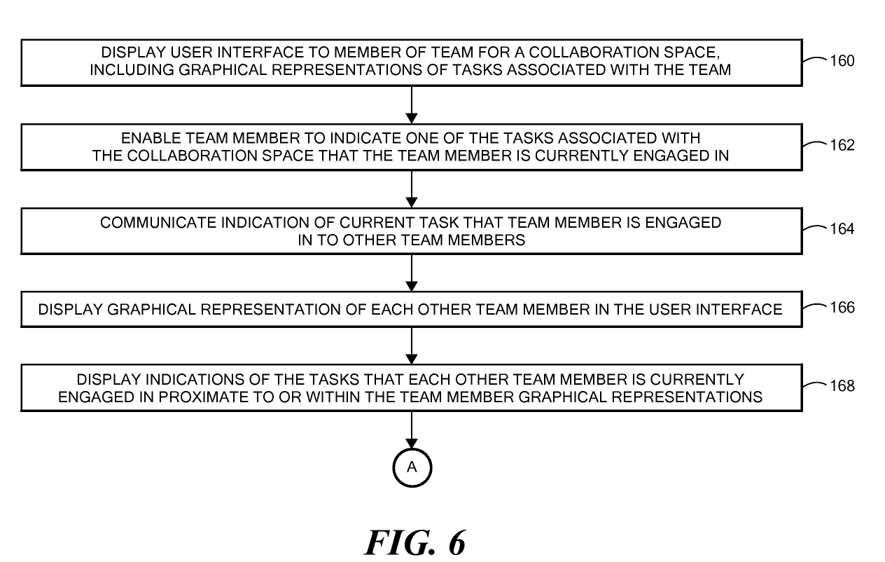

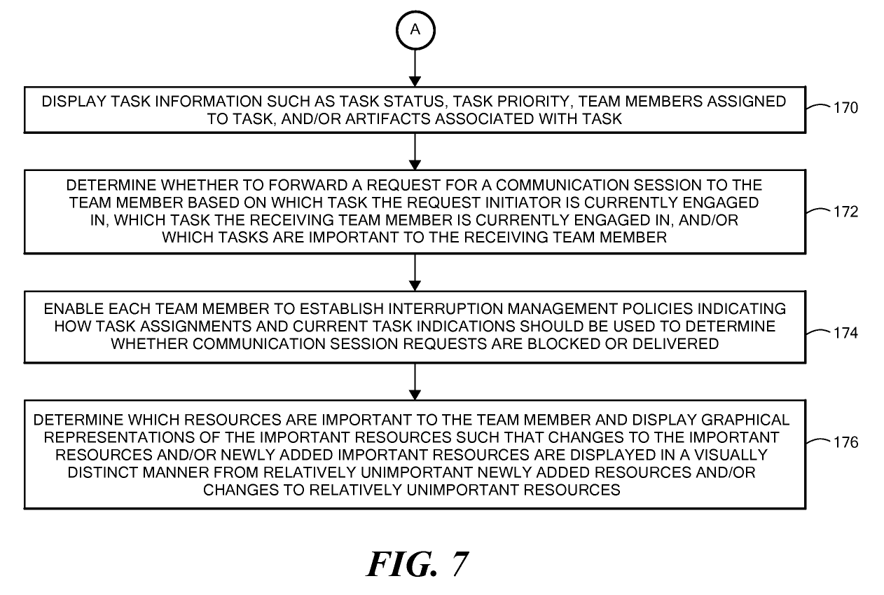

FIGS. 6 and 7 are a flow chart illustrating steps performed in an embodiment of the disclosed system. At step 160, the disclosed system displays a user interface to a member of a team space. The user interface displayed at step 160 includes graphical representations of tasks associated with a team, such as the task representations in the tasks user interface component 103 of FIG. 2.

At step 162, the disclosed system enables the team member to indicate one of the tasks associated with the team space that they are currently engaged in, such as through the current task user interface component 105 shown in FIG. 2. The disclosed system operates at step 164 to communicate the indication of the team member's current task, as indicated at step 162, to the other members of the team space. For example, the current task indication may be communicated by way of a communication network or the like from the client computer system of the user to a team space application on a remote team space computer system, and then conveyed to client computer systems of the other team members from the team space computer system over the same or another communication network.

The disclosed system displays graphical representations of each other team member in a user interface at step 166, such as the representations 112 of the other team space members shown in FIG. 2. Further, at step 168, indications of the task that each other team member is currently engaged in are displayed in proximity or within the team member graphical representations provided at step 166. In one embodiment, the current task information provided at step 168 is displayed through a hover over display component such as the display component 116 of FIG. 2. Alternatively, the current task information may be provided at step 168 in visual proximity to or within the representation of an artifact, such as through the display component 123 of FIG. 3.

The disclosed system operates at step 170 to display task information, such as status, priority, team members assigned to a task, and/or which artifacts are associated with a task. For example, such information may be provided in a hover over display window such as the hover over display components 116 of FIGS. 2 and 123 of FIG. 3, albeit provided when the user hovers the cursor over a task representation, such as the task representations in the user display component 103 of FIG. 2. Alternatively, such task information may be provided to the user by way of the task representation itself, such as through a first type of icon located next to each task that is completed, a second type of icon located next to each task that is underway, another type of icon located next to each task that is planned, etc. Similarly, special visual characteristics may be associated with corresponding task priorities, such that higher priority tasks are represented in one color, while lower priority tasks are represented in another color.

In another embodiment, as shown in the user interface component 105 of FIG. 2, the artifacts and/or other information associated with a task may be displayed as part of a tree or outline view in the user interface.

At step 172, requests for communication sessions between team members may be controlled based on task assignments and current task indications. For example, the disclosed system may operate to prevent communication session requests from being forwarded to and/or displayed to a receiving team member unless the team member requesting the communication session is currently engaged in a task to which the receiving team member is assigned. Similarly, the disclosed system may operate to prevent communication session requests from being forwarded to and/or displayed to a receiving team member unless the team member is currently engaged in the same task that the receiving team member is engaged in. Task importance may further be used to control which communication session requests are forwarded to a receiving team member. For example, the disclosed system may operate to prevent communication session requests from being forwarded to and/or displayed to a receiving team member unless the team member requesting the communication session is currently working on a task that the receiving team member has indicated is an important task.

At step 174, the disclosed system enables each team member to establish interruption management policies, such as the Interruption Management Policies 15 of FIG. 1. The interruption management policies established at step 174 indicate how task assignments and current task indications should be used to determine whether communication session requests are forwarded to a receiving team member or blocked.

At step 176, the disclosed system operates to determine which Team Space resources are important to a team member, and to display graphical representations of the important resources such that changes to important resources, and/or new resources, are displayed in a visually distinct manner from changes to and/or newly created less important resources. An example of how such visually distinct representations may be presented is shown in FIG. 5.

The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative graphical user interface constructs, one skilled in the art will recognize that they may be embodied using a variety of other alternative graphical user interfaces.

We claim:

1. A method of providing a virtual collaboration space, comprising:
displaying, in a user interface provided to a member of a team, graphical representations of tasks associated with said team;
enabling said member of said team to provide an explicit indication through said user interface of one of said tasks associated with said team that said member of said team is currently engaged in; and
displaying an indication of which of said tasks associated with said team said member of said team is currently engaged in to other members of said team, responsive to said explicit indication of said one of said tasks associated with said team that said member of said team is currently engaged in.

2. The method of claim 1, wherein said tasks associated with said team include tasks that are planned, tasks that are completed, and tasks that are ongoing.

3. The method of claim 1, further comprising:
displaying a graphical representation of each other member of said team in said user interface provided to said member of said team; and
displaying, proximate to corresponding ones of said graphical representations of each other member of said team, an indication of which of said tasks associated with said team each other member of said team is currently engaged in.

4. The method of claim 3, further comprising displaying, in said user interface provided to said member of said team, information associated with each of said tasks associated with said team, wherein said information associated with each of said tasks includes at least one of the set consisting of status of the task, priority of the task, a description of the task, team members assigned to the task, and resources associated with the task.

5. The method of claim 1, further comprising:
receiving a request for a communication session with said member of said team;
determining whether to forward said request for said communication session to said member of said team through said user interface provided to said member of said team responsive to which of said tasks said member of said team is currently engaged in and which of said tasks an initiator of said request for said communication session is currently engaged in; and
forwarding said request for said communication session to said member through said user interface provided to said member of said team in the event that both said member of said team and said initiator of said request for said communication are both currently engaged in the same task.

6. The method of claim 1, further comprising:
receiving a request for a communication session with said member of said team;
determining whether to forward said request for said communication session to said member of said team through said user interface provided to said member of said team responsive to which of said tasks said member of said team considers to be important and which of said tasks an initiator of said request for said communication session is currently engaged in; and
forwarding said request for said communication session to said member through said user interface provided to said member of said team in the event that said initiator of said request for said communication is currently engaged in a task that is important to said member of said team.

7. The method of claim 1, further comprising:
enabling each of said members of said team to explicitly establish interruption management policies indicating how task assignments and current task indications of a team member initiating a request for a communication session should be used to determine whether a request for a communication session should be forwarded to a receiving team member.

8. The method of claim 1, further comprising:
determining which resources are important to said member of said team; and
displaying graphic representations of said important resources such that changes to said important resources are displayed in a visually distinct manner from changes to other resources.

9. The method of claim 8, wherein said changes to said important resources are displayed in a first predetermined color, and wherein changes to said other resources are displayed in a second predetermined color.

10. The method of claim 8, wherein said determining which resources are important to said member of said team is responsive to which tasks said member of said team is assigned to, and to which resources are associated with said tasks said member of said team is assigned to, such that said resources associated with said tasks said member of said team is assigned to are determined to be important to said member of said team.

11. The method of claim 10, wherein said resources that are important to said member of said team comprise at least one artifact of said virtual collaboration space.

12. The method of claim 8, wherein said resources that are important to said member of said team comprise at least one task, and wherein said determining which resources are important to said member of said team is responsive to which tasks said member of said team is assigned to, such that said tasks said member of said team are assigned to are determined to be important to said member of said team.

13. A system including a computer readable medium, said computer readable medium having program stored thereon for providing a virtual collaboration space, said program code comprising:
program code for displaying, in a user interface provided to a member of a team, graphical representations of tasks associated with said team;
program code for enabling said member of said team to provide an explicit indication through said user interface of one of said tasks associated with said team that said member of said team is currently engaged in; and
program code for displaying an indication of which of said tasks associated with said team said member of said team is currently engaged in to other members of said team, responsive to said explicit indication of said one of said tasks associated with said team that said member of said team is currently engaged in.

14. A computer program product including a computer readable medium, said computer readable medium having program stored thereon for providing a virtual collaboration space, said program code comprising:
program code for displaying, in a user interface provided to a member of a team, graphical representations of tasks associated with said team;
program code for enabling said member of said team to provide an explicit indication through said user interface of one of said tasks associated with said team that said member of said team is currently engaged in; and
program code for displaying an indication of which of said tasks associated with said team said member of said team is currently engaged in to other members of said team, responsive to said explicit indication of said one of said tasks associated with said team that said member of said team is currently engaged in.

15. A computer data signal embodied in a carrier wave, said computer data signal having program code stored thereon for providing a virtual collaboration space, said program code comprising:
program code for displaying, in a user interface provided to a member of a team, graphical representations of tasks associated with said team;
program code for enabling said member of said team to provide an explicit indication through said user interface of one of said tasks associated with said team that said member of said team is currently engaged in; and
program code for displaying an indication of which of said tasks associated with said team said member of said team is currently engaged in to other members of said team, responsive to said explicit indication of said one of said tasks associated with said team that said member of said team is currently engaged in.

16. A system for providing a virtual collaboration space, comprising:
program code for displaying, in a user interface provided to a member of a team, graphical representations of tasks associated with said team;
program code for enabling said member of said team to provide an explicit indication through said user interface of one of said tasks associated with said team that said member of said team is currently engaged in; and
program code for displaying an indication of which of said tasks associated with said team said member of said team is currently engaged in to other members of said team, responsive to said explicit indication of said one of said tasks associated with said team that said member of said team is currently engaged in.
